(19) United States
(12) Patent Application Publication
(10) Pub. No.: US 2009/0079555 A1
(43) Pub. Date: Mar. 26, 2009

(54) SYSTEMS AND METHODS FOR REMOTELY CONFIGURING VEHICLE ALERTS AND/OR CONTROLS

(76) Inventors: Giadha Aguirre De Carcer, Washington, DC (US); Ionio Aguirre De Carcer, Miami, FL (US); Raymond Rugunda, Kampala (UG); Gabino Guerengomba, Ashburn, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 12/122,088

(22) Filed: May 16, 2008

Related U.S. Application Data
(60) Provisional application No. 60/938,546, filed on May 17, 2007.

(51) Int. Cl. B60Q 1/00; G06F 17/00

(52) U.S. Cl. 340/441; 340/438; 701/2

(57) ABSTRACT

The present invention provides systems and methods for remotely configuring a mobile device communicatively coupled with a vehicle. The mobile device receives current GPS and vehicle information and transmits the information to a remote server. The remote server displays vehicle and/or driver information to remote users via a user interface. The user interface provides remote users the ability to remotely configure the mobile device according to user-customizable settings. In embodiments, configurations may be made in real-time and/or on-the-fly. In further embodiments, the server receives data feeds from a variety of external data sources and integrates the data to provide recommended vehicle configurations.

### CROSS-REFERENCE TO RELATED APPLICATIONS

This application relies on the disclosure of and claims the benefit of the filing date of U.S. provisional patent application No. 60/938,546, filed 17 May 2008, the entire disclosure of which is hereby incorporated herein by reference.

### BACKGROUND OF THE INVENTION

1. Field of the Invention

The present invention generally relates to the field of mobile positioning. More specifically, the present invention relates to remote vehicle monitoring and/or control.

2. Description of Related Art

Vehicle positioning devices generally exist that provide global positioning data, maps and other features. Such mobile positioning devices may be mounted in a vehicle and coupled to a vehicle computer or diagnostic system. Typically vehicle positioning devices are pre-configured according to the manufacturer's standards. However, some devices allow a driver to enter basic information, such as destination, restaurants, etc. though a keypad or display located on the housing.

In addition, prior art systems and methods exist that allow for tracking and monitoring of vehicle functions. However, such prior art systems and methods do not allow users (such as fleet managers or owners) to remotely configure the mobile devices in real-time. In addition, remote users are not able to configure the devices according to user-customizable settings. Moreover, such prior art systems and methods do not intelligently determine recommended vehicle configurations based on one or more up-to-date external data feeds.

Thus, while current mobile positioning systems generally allow for tracking and monitoring of vehicles, the inventors have realized that there remains a need for increased remote user interaction. Furthermore, they have realized that a need exists for remotely customizing alert and/or control features. They have also realized that there is further a need for providing alerting and/or control functions in response to intelligently determined recommended settings.

### SUMMARY OF THE INVENTION

The present disclosure provides solutions to needs in the art by providing systems and methods that allow users (such as fleet managers or owners) to remotely configure a mobile positioning device communicatively coupled with a vehicle. In embodiments, configurations may be made according to user-customizable settings. To further address one or more drawbacks of the prior art, disclosed embodiments allow for integration of one or more external data feeds to determine recommended vehicle settings. Data from the external sources may be applied to a recommendation algorithm to provide recommended vehicle settings. Such settings may include recommended speed, acceleration, and more. For example, mobile device data and up-to-date traffic data may be received at a host server or processor and combined to provide a suggested speed for purposes of efficient fuel usage. In another example, mobile device position/speed data and dynamic weather data may be received by a host server or processor and combined to provide a new suggested speed for purposes of improved safety.

According to one aspect, a method for remotely configuring a mobile device communicatively coupled with a vehicle is disclosed, the method comprising: providing a remote user interface whereby a user may input user-customizable mobile device settings; and wirelessly configuring the mobile device based on the user-customizable settings. In embodiments, the mobile device is wirelessly configured by a remote user to flag, provide alerts, and/or cap vehicle speeds or accelerations above a threshold specified by the user. In embodiments, the mobile device is wirelessly configured to communicate vehicle data or flags to the user according to a communication protocol and/or time interval specified by the user. User-customizable settings may be updated via the user interface on-the-fly. Alternatively, configurations may be scheduled to take place during “off peak” times to make efficient use of bandwidth and/or reduce transmission costs.

According to another aspect, a method for remotely configuring a mobile device communicatively coupled with a vehicle is disclosed, the method comprising: receiving data from the mobile device at a remote server; receiving one or more external data feeds at the server; inputting the mobile device data and/or external data to a recommendation algorithm; applying the recommendation algorithm to calculate recommended vehicle settings; and wirelessly configuring the mobile device based on the recommended settings. In addition, the mobile device may be wirelessly configured by a remote user to flag, provide alerts of, and/or cap vehicle speeds or accelerations above a recommended setting. In embodiments, the recommendation algorithm combines the mobile device data and external data to provide recommended vehicle settings. In further embodiments, the recommendation algorithm may utilize artificial neural networks, modular neural networks, fuzzy systems, expert rules, correlation analysis, weights, etc. to provide recommended settings. The mobile device may be configured on-the-fly, or configurations may be scheduled to take place during “off peak” times to make efficient use of bandwidth and/or reduce transmission costs.

According to a further aspect, a system for enabling a user to remotely configure a mobile device communicatively coupled with a vehicle is disclosed, the system comprising: a mobile device in operative communication with a global positioning system and a remote server, the remote server including: a vehicle data receiving module; a user interface module configured to display vehicle and/or driver data to the user; an input module configured to receive customizable settings from the user; and a transmission module configured to transmit configuration settings to the mobile device in response to the user inputs; whereby the mobile device is wirelessly configured based on the user-customizable settings. In embodiments, the mobile device is wirelessly configured to flag, provide alerts of, and/or cap vehicle speeds or accelerations above a threshold specified by the user. In embodiments, the mobile device is wirelessly configured to communicate vehicle data or flags to the user according to a communication protocol and/or time interval specified by the user. The user interface may be configured to receive customizable configuration inputs from the user on-the-fly, or may be configured to make updates at scheduled times e.g., to reduce bandwidth and/or transmission costs.

Preferably, the disclosed systems and methods provide intelligent vehicle alerts and/or controls based on real time GPS and/or location based technology and external data feeds. In addition, the systems and methods described in the present disclosure are able to utilize global positioning and/or location-based technology to provide real time speeding alerts and to track driving behavior over time. Driver history data may be used to evaluate driver risk and/or calculate a driver “score” to encourage safe driving, reduce insurance premiums, and more. Additionally, operators can utilize global positioning and/or location-based technology to prevent inefficient fuel usage due to speeding.

Further advantages to the systems and methods disclosed herein include: improved remote user interaction; intelligently determined recommended configurations, updates in real time, improved vehicle safety, reduced risk of accidents, improved fuel efficiency, reduced insurance premiums, and overall cost savings.

### BRIEF DESCRIPTION OF THE DRAWINGS

FIG. 1a is a system for providing remote customized vehicle alerts and/or controls according to an exemplary embodiment of the disclosure.

FIG. 1b is a system for providing remote customized vehicle alerts and/or controls according to another exemplary embodiment of the disclosure.

FIG. 2a depicts exemplary remote server components according to the principles of the present disclosure.

FIG. 2b depicts exemplary mobile device components according to the principles of the present disclosure.

FIG. 3 illustrates an exemplary user interface Log-In page.

FIGS. 4a and b illustrate exemplary user interface Real Time Summary pages.

FIG. 5 illustrates an exemplary user interface current, or Real Time Alerts View page.

FIG. 6a and b illustrate exemplary user interface Driver Profile and Driver History pages, respectively.

FIG. 7 illustrates an exemplary user interface customizable configurations page.

FIG. 8 is a flowchart showing a remote vehicle configuration flowchart according to one embodiment of the present disclosure.

FIG. 9 is a flowchart showing reconfiguration of mobile device according to another embodiment of the present disclosure.

FIG. 10 is a flowchart showing remote configuration of device via a user interface according to yet another embodiment of the present disclosure.

FIG. 11 is a flowchart of a recommendation algorithm according to the present disclosure.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description is provided to supply a fuller description of certain embodiments of the invention, and is not intended as a limiting disclosure of all embodiments of the invention. Rather, those of skill in the art will be able to understand the full scope of the invention after consideration of the above broad description, the following detailed description of certain embodiments, and the claims.

### System Overview

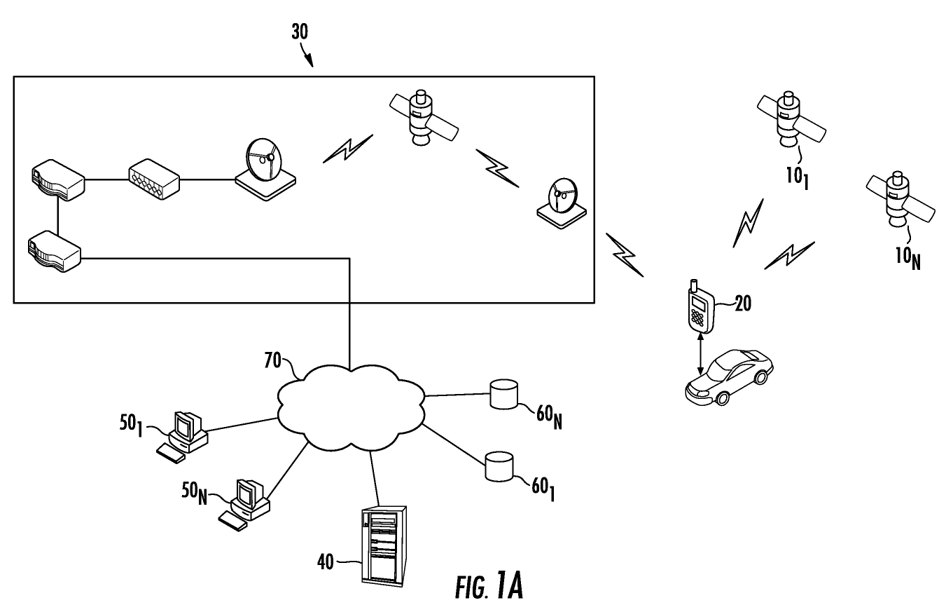

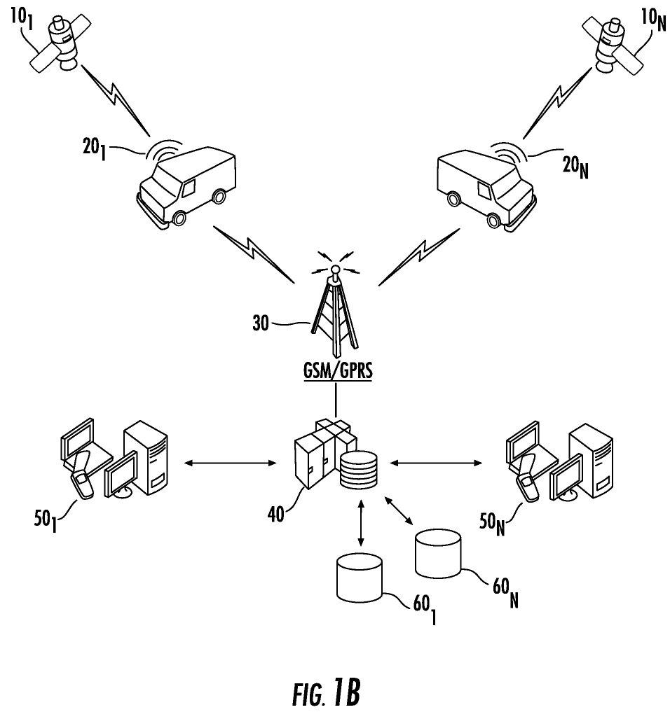

FIG. 1a illustrates a system for providing remote customized vehicle alerts and/or controls according to a preferred embodiment of the present disclosure. As shown, a mobile device 20 is communicatively coupled with a vehicle. Mobile device 20 may be a smart phone, pocket PC, cell phone, two-way pager, iPod, personal digital assistant (PDA), laptop, or other personal communication system. Although only one mobile device 20 and associated vehicle are shown for illustration purposes, it is understood that the system may include multiple such devices 20. Mobile device 20 may be physically or wirelessly coupled with a vehicle diagnostic or control system, such as an on-board diagnostic (OBD II) unit, using e.g., a J1850 or CAN bus/interface as will be appreciated by those skilled in the art. In addition, the mobile device 20 may be associated with a truck, bus, automobile, motorcycle, boat, ship, or other personal or commercial transportation device.

The mobile device 20 wirelessly communicates with a global navigation satellites 10_{1-N} (hereinafter “GPS system,” 10) to obtain positioning data. In addition, the mobile device 20 communicates with a server 40 via a wireless communication system 30 and network 70 to transmit vehicle data and to receive configuration settings and data. Network 70 may include a variety of networks, including but not limited to: LANs, WANs, MANs, PANs, the Internet, Intranets, or other public or private networks. Remote user devices 50_{1-N} may also communicate with server 40 over network 70 to communicate user-customizable settings. Remote user devices 50_{1-N} include, but are not limited to: PCs, laptops, personal digital assistants (PDAs), and cell phones. For illustration purposes, a single remote user device 50 will herein be used by way of example. In embodiments, the server 40 is additionally in communication with one or more external data sources, or databases 60_{1-N} for receiving external data feeds.

The mobile device 20 thus communicates vehicle data (such as position, speed, acceleration, alerts, vehicle diagnostic data, or other activity) to the remote server 40. Data is also periodically exchanged between the mobile device 20 and GPS system 10, to receive the vehicle's position. In embodiments, the mobile device 20 allows for GPS/GSM/GPRS/TDMA/CDMA and/or 802.11 communication and tracking functionality.

Preferably, the mobile device 20 is able to wirelessly receive configuration settings from the server 40. For example, a remote user (such as a fleet manager or owner) may configure the device 20 via the server 40 to send real time alerts when the vehicle speed is over the legal speed limit for that location. Alternatively, the remote user may configure the device 20 to store alerts and send a log of incidents to the server 40 once a day, e.g., during “off times”. In another example, a remote user may configure the mobile device 20 to set a vehicle speed cap at the current legal speed limit, at a user-specified threshold above or below the legal speed limit, or other customizable setting. The mobile device 20 thus serves as an interface between an in-vehicle GPS system, an in-vehicle signaling device, and an in-vehicle speed control governing system. For example, the mobile device 20 may be interfaced to a vehicle control system such as a cruise control system, fuel injection system, ignition system, etc. Preferably, the mobile device 20 and vehicle control system may be overridden by the driver if necessary.

The GPS system 10 is used to provide mobile device 20 location, speed, direction, and time of fix from a network of satellites. Exemplary global navigation satellite systems include: global positioning system (GPS), GLONASS, Galileo positioning system, COMPASS navigational system, and IRNSS. However the GPS system will be primarily addressed herein, by way of example.

The wireless communication system 30 may include e.g., satellite and/or cellular providers or carriers. The wireless communication system 30 as shown in FIG. 1a shows an exemplary satellite provider architecture which may include: satellite dishes, ISCPC/TDMA Satcom Routers, hubs, protocol processors, teleport routers, etc. as provided, for example, by iDirect, Inc., Herndon, Va. Preferably, the wireless communication system 30 supports GSM/GPRS communication functionality, TCP/HTTP acceleration, Application QoS, IP routing, compressed real time protocol (cRTP), and encryption. Advantageously, the wireless communication system 30 may include adaptive return channels which allow for efficient and cost effective user of bandwidth and improved system efficiency.

In addition, the server 40 may be part of a host infrastructure which may also include firewalls, routers, VPNs, network accelerators, web servers, databases, data stores, database servers, e-mail servers and back-up servers, and other network components as will be appreciated by those skilled in the art. Operationally, remote users may access the server 40 over network 70 to view and obtain vehicle and/or driver information. Network 70 may include a variety of networks, including but not limited to: LANs, WANs, MANs, PANs, the Internet, Intranets, or other public or private networks. Preferably, the server 40 may be accessed utilizing a variety of network communication protocols including, but not limited to: HTTP, FTP, RTP, SMTP, WAP, SMS and MMS. In embodiments, a user interface provided by the server 40 allows remote users to interact with the mobile device 20 e.g., in real-time and/or on-the-fly.

The server 40 may further comprise one or more PCs or mainframes as will be understood by those skilled in the art. In addition, it is appreciated that server 40 may include one or more collocated and/or remote processors. In embodiments, the server 40 uses Microsoft Server 2003™ standard (or higher) and Microsoft IIS 6™ (or higher). Alternatively, the server 40 may be an IBM™ or Sun™ server running an operating system such as Solaris™, Unix™ or Linux. In embodiments, the server 40 uses an open source or open service oriented architecture to allow external data sources to connect and provide dynamic and/or continuously updated data.

Preferably, the server 40 provides a web portal for receiving customized input from user devices 50, and communicates configuration settings to the mobile device 20 via wireless network 30. Additionally, server 40 may obtain external data from one or more host databases and/or data sources 60. Examples of external data include, but are not limited to: traffic data, legal speed limit data, weather data, road condition data, roadside work data, emergency services data, and data from other vehicles.

FIG. 1b illustrates another exemplary embodiment of the disclosure. Although multiple mobile devices 20_{1-N} are shown, for simplicity purposes, a single mobile device 20 will be hereinafter addressed in a similar manner as FIG. 1a. Mobile device 20 may be a smart phone, pocket PC, cell phone, two-way pager, iPod, personal digital assistant (PDA), laptop, or another personal communication system. As shown, the mobile device 20 wirelessly communicates with GPS satellites 10_{1-N} to obtain positioning data. The mobile device 20 also communicates with a server 40 via a wireless communication system 30 to transmit vehicle data and to receive configuration settings and data. In this embodiment, the wireless communication system 30 includes a cellular carrier which may further include: Mobile Switching Centers (MSCs), multiple base stations (BTS), portions of the Internet and/or POTS networks, SMSCs, and other network components as will be appreciated by those skilled in the art. Remote user device 50_{1-N} (generally referred to as device 50) may also communicate with the server 40 to enter user-customizable settings. In practice, the wireless communication system 30 and remote user device 50 communicate with server 40 over a variety of networks (not shown) including, but not limited to: LANs, WANs, MANs, PANs, the Internet, Intranets, or other public or private networks. Remote user devices 50 include, for example: PCs, pocket PCs, laptops, personal digital assistants (PDAs), smart phones, and cell phones. In embodiments, the server 40 is additionally in communication with one or more external data sources or databases 60_{1-N}. Other than the wireless communication system 30, the system components of FIG. 1b are similar to the system components as described in FIG. 1a.

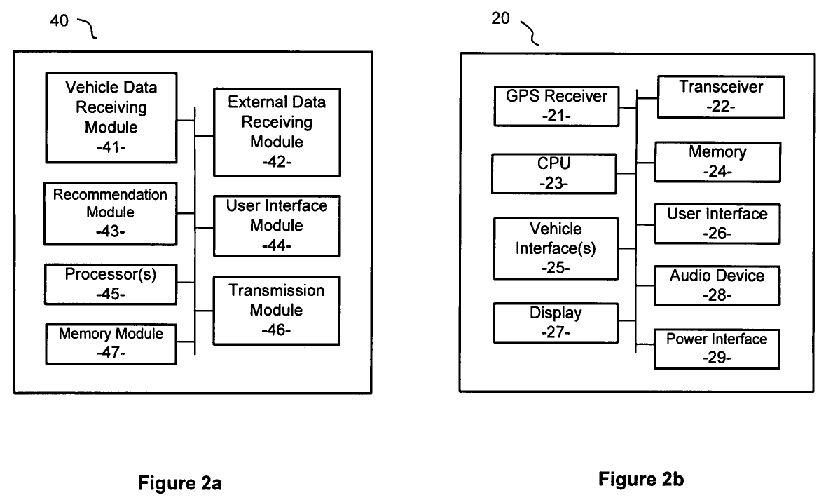

FIG. 2a shows various server 40 modules according to an exemplary embodiment of the disclosure. For example, server 40 may further include: a vehicle data receiving module 41; an external data receiving module 42; a recommendation module 43; a user interface module 44; processors 45; transmission module 46; and a memory module 47. It is appreciated that the above modules are in physical, wireless and/or logical communication with one another and may be implemented in the form of hardware and/or software instructions. The modules may include custom macros, subroutines, logic, etc. implemented using commercially available software as will be understood by those skilled in the art. In addition, it will be appreciated by those skilled in the art that the modules may be implemented in various configurations are not limited to the configurations disclosed herein, and that the modules may be combined in various manners to perform the functions disclosed herein.

As shown in FIG. 2b, the mobile device 20 includes, for example: a GPS receiver 21, a wireless transceiver or modem 22, a central processing unit 23, memory 24, vehicle interface(s) 25, a user interface 26, a display 27, an audio device 28, and a power interface 29. It is appreciated that such components are in physical, wireless and/or logical communication with one another and may be located within the mobile device 20 housing, or may be external to the device 20. In embodiments, mobile device 20 may be a cell phone, two-way pager, iPod, personal digital assistant (PDA), laptop, pocket PC, smart phone, or other personal communication system.

The GPS receiver 21 receives vehicle position data from global positioning system 10 and uses the position data to calculate device 20 location, speed, direction, and/or time of fix. For example, the GPS receiver 21 may include a SiRF Star III™ chipset for tracking up to twenty satellites.

The wireless transceiver 22 may be a TDMA or SCPC modem (if a satellite carrier is used), a TDMA, CDMA, GSM, GPRS and/or 802.11 modem, or other device capable of wirelessly sending and receiving data according to the functions disclosed herein. Preferably, the transceiver 22 enables TCP/HTTP acceleration, application QoS, IP routing, compressed RTP, and encryption.

The CPU 23 may include an operating system such as Windows Mobile™ 5.0, or higher, (by Microsoft, Inc., Redmond, Va.) or other flexible operating system. Preferably, the operating system is scalable, extensible, easily configurable and provides familiar APIs. The operating system should also support network protocols including, but not limited to: TCP/IP, IPv4, IPv6, 802.11, WEP, HTTP, FTP, SMTP, POP3, WAP, SMS, MMS, RTP, NAT, IPsec, PPTP, and L2TP, and support various encryption protocols including, but not limited to: DES, 3DES, BLOWFISH, AES and RSA as well as hash algorithms, key exchange protocols and digital certificates. Preferably, the operating system allows for new sections of software code to be introduced and/or downloaded from a remote development host in real time and for remote software updates.

The mobile device 20 also includes memory 24 for storing data and software instructions for performing the functions disclosed herein. Various data or data layers stored on device 20 include: vehicle speed, vehicle acceleration, vehicle activity, driver data, vehicle diagnostic data, map data, traffic data, weather data, or other vehicle or downloaded data. For example, downloaded map data may include Google Maps™ (by Google, Inc., Mountain View, Calif.), Virtual Earth™ (by Microsoft, Inc., Redmond, Wash.), etc. Types of memory include, but are not limited to: ROM, RAM, SRAM, EEPROM, and flash memory. Preferably, the software instructions and/or data may be laid on top of the device hardware such that, when executed, cause the mobile device 20 to: calculate vehicle speed; calculate vehicle rate of acceleration; compare vehicle location and speed to speed limit data on a map layer; flag speeding; flag inefficient acceleration; recognize driver id; regulate transmission timing based on device status; wirelessly receive device programming details to configure alert and/or control updates (such as changes to speed flags or alert type); and/or process and leverage other data layers (such as road work, weather alerts, emergency response, or traffic).

Vehicle interface(s) 25 are used to receive vehicle diagnostic data and communicate control settings to the vehicle. Such vehicle interface(s) 25 may include a speed control interface, cruise control interface, fuel injection control interface, ignition control interface, or any other interface for controlling vehicle functions. In embodiments, the CPU 23 communicates with vehicle interface 25 to cap vehicle speed at the current legal speed limit, cap vehicle speed above or below the legal speed limit in response to user-customized settings, cap vehicle speed and/or acceleration according to recommended setting(s), etc.

User interface 26 may be used to receive a driver ID and/or other driver input. In embodiments, the interface 26 includes a keypad, touch screen, push buttons, quick dial buttons for dialing preset numbers, mouse, pointing device, joystick, or other mechanism for entering information into the device.

Display 27 is used to communicate visual alerts and other stored or downloaded information to the driver of the vehicle. For example, visual alerts may include current speed limit, excessive speed, or acceleration warnings. Additional information displayed may include: maps, weather information, and/or traffic information. Display 27 may also be used to display various forms of downloaded multimedia content and more. In embodiments, the display 27 may be an LCD display, LED display, or other device for visually communicating information to the driver. Audio device 28 is used to communicate audio alerts and other information to the driver. In embodiments, the audio device 28 may include a built-in speaker, low power alarm, earphones, or other mechanisms for audibly communicating with a user.

Additionally, the mobile device 20 may include a power interface 29 to provide power to the mobile device 20. For example, the power interface 29 may include a mini USB port for obtaining power from the vehicle. Additionally and/or alternatively, a battery source such as a swappable and rechargeable Li-Ion battery may be provided. In this manner, the mobile device 20 may receive power independent from the vehicle, for example in the event of a vehicle “break-down” or power failure.

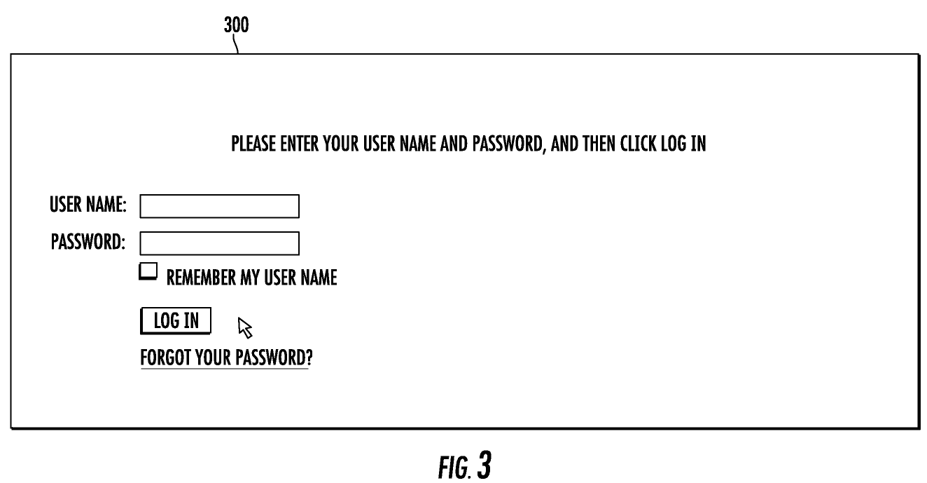

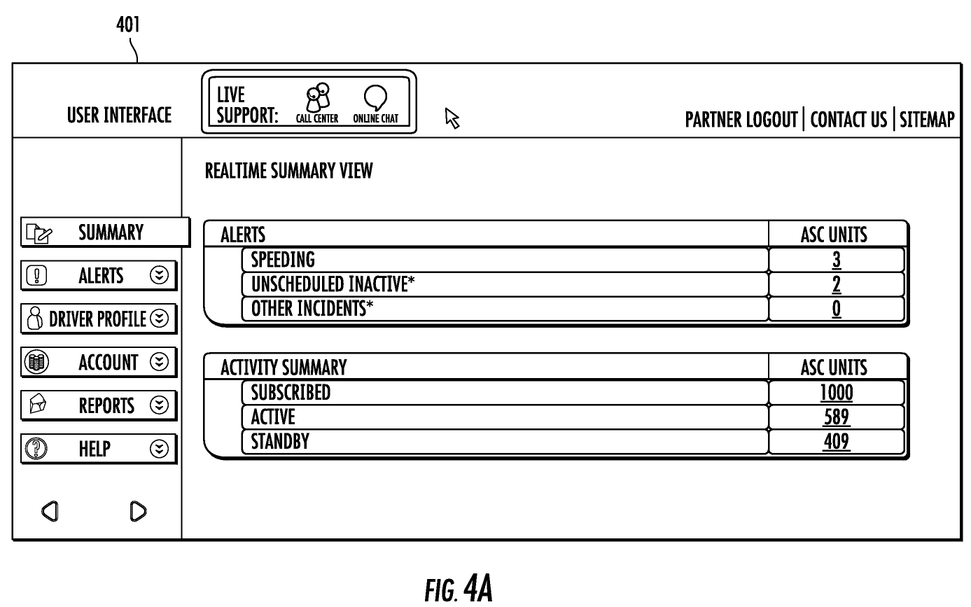

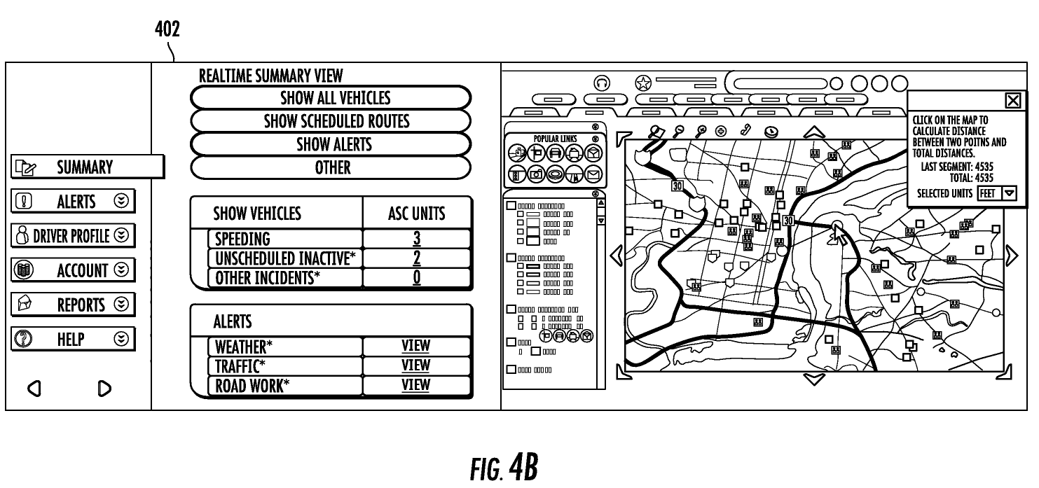

FIG. 3 illustrates an exemplary user interface log-in page 300. According to embodiments, the log-in page 300 is configured to allow authorized users to enter a secure web portal by entering a unique user ID and password. The log-in page 300 may remember the user ID on the terminal used, email the password to the user if forgotten, and/or reset the password.

FIG. 4a illustrates an exemplary user interface Real Time Summary View page 401. As shown, “Alerts” provides a snapshot of all units speeding, unscheduled inactive, and other incidents (such as unreasonable acceleration). The Real Time Summary View page 401 is also configured to provide the user with the ability to “dig-down” for further data by clicking on the “units” to see further details. For example, the snapshot for “Speeding” provides a tally of all devices having flagged speeding (as set for the day, for the hour, every two hours, etc.), the snapshot of “Unscheduled Inactive” provides a tally of all devices having flagged unscheduled inactivity (as set for the day, for the hour, every two hours, etc.); the snapshot for “Other Incidents” provides a tally of all devices having flagged incidents such as unreasonable acceleration (as set for the day, for the hour, every two hours, etc.). As further shown in FIG. 4a, the “Activity Summary” provides a snapshot of all mobile units' status based on the total Subscribed units. The Activity Summary also includes a tally of Active (e.g., on the road) units, and Standby (e.g., subscribed, but not currently on the road) units. FIG. 4b depicts another Real Time Summary View page 402 providing additional data such as “Show All Vehicles,” “Show Scheduled Routes,” “Show Vehicles” (e.g., speeding, unscheduled inactive, other incidents), “Alerts” (e.g., Weather, Traffic, Road Work), and “Other” data. As shown, such data may be illustrated on an interactive map for quick visualization and user interaction.

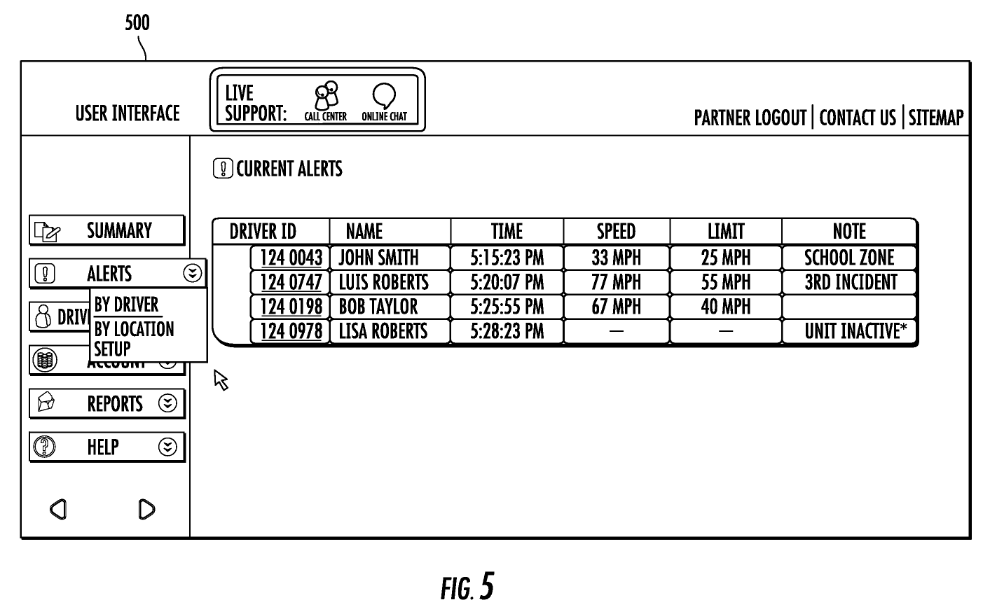

FIG. 5 illustrates an exemplary user interface current, or “Real-Time,” alerts page 500. The alerts may be sorted e.g., by driver, date, location, or other display criteria. If driver is selected, the user interface may be configured to display: driver ID, name, time, speed, limit, comment data, type of incident, and/or number of incidents (as set for the day, week, month, etc.). For example, if the incident is a speeding incident, the time of the speeding incident, the speed at the time of the incident, the speed limit at the time of the incident, and/or the location of the incident, may additionally be displayed. If the incident is an acceleration incident, the number of total ‘unreasonable/inefficient’ acceleration incidents (as set for the day, week, month, etc.) may also be displayed. If the incident is an unscheduled activity, the time of the incident, or period of time while inactive may be displayed.

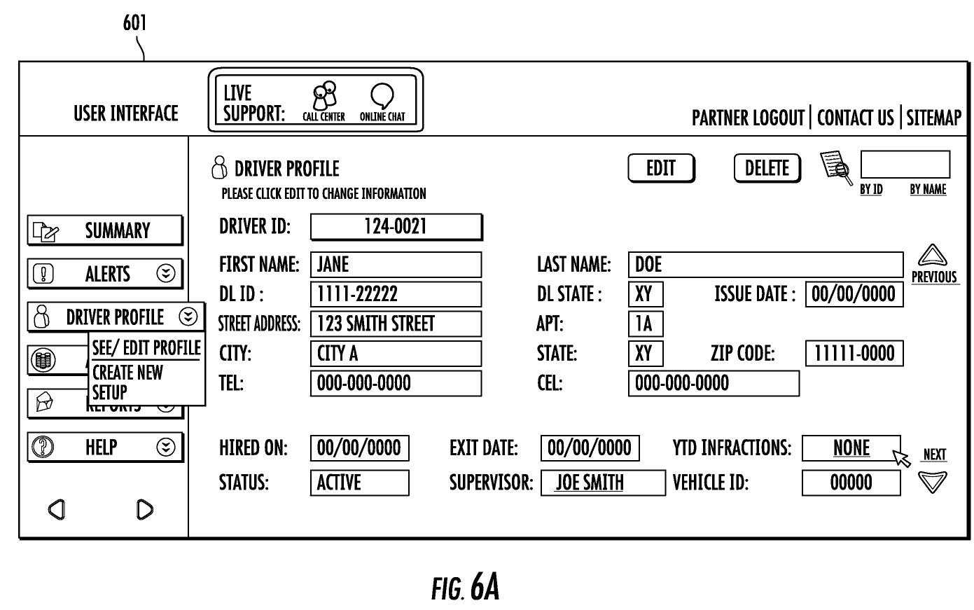

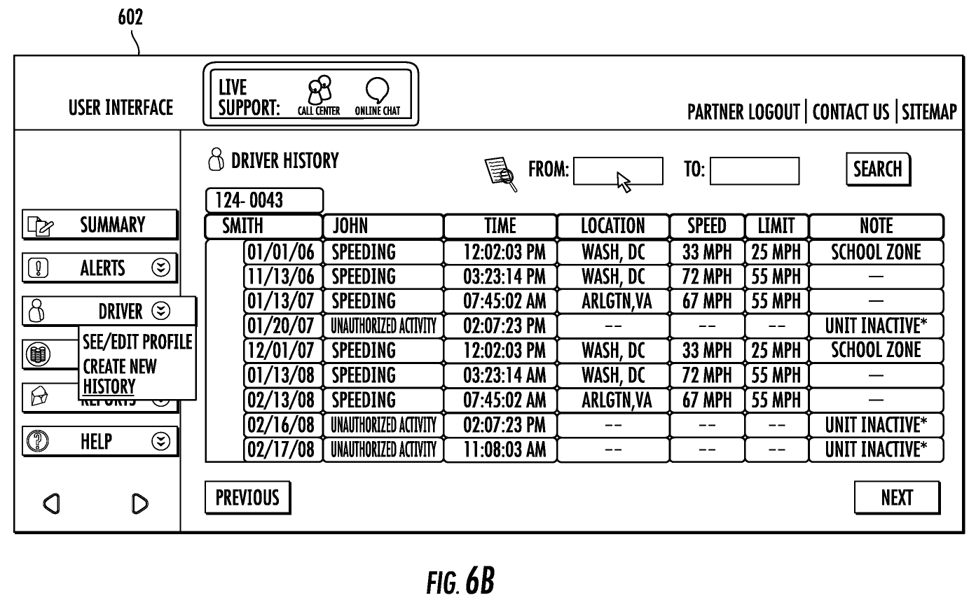

FIG. 6a illustrates an exemplary user interface “Driver Profile” page 601. The Driver Profile page 601 may be configured to display information such as: driver ID, name, address, telephone number, driver's license state, hiring information, status, supervisor, year-to-date infractions, or other additional driver information. For example, the year-to-date infractions may include a summary view of the total number and may be displayed by most recent first, most serious first, or other preferred format. The driver profile may be edited by an authorized user (such as a fleet manager or system administrator). In embodiments, the driver profile may be updated by external data feeds such as police reports, DMV records, reports of careless driving by motorists, or other external data sources.

FIG. 6b illustrates an exemplary user interface “Driver History” page 602. In embodiments, the Driver History page 602 is configured to allow an authorized user to create custom reports that indicate: driver, alert or incident type, date or date range, time or time range, or location (such as county, city, state, region or country). It is appreciated that driver history data may be used to compile data regarding driver behavior and/or to assess a driver risk factor. Such data may further be used to compile a “driver score” or “ranking” e.g., as compared with predetermined criteria, other drivers, etc. Driver scores or rankings may be used to for fleet personnel evaluations, insurance purposes, and more. For example, a driver with a good or excellent driver score may be eligible for lower insurance premiums, employee bonuses, etc.

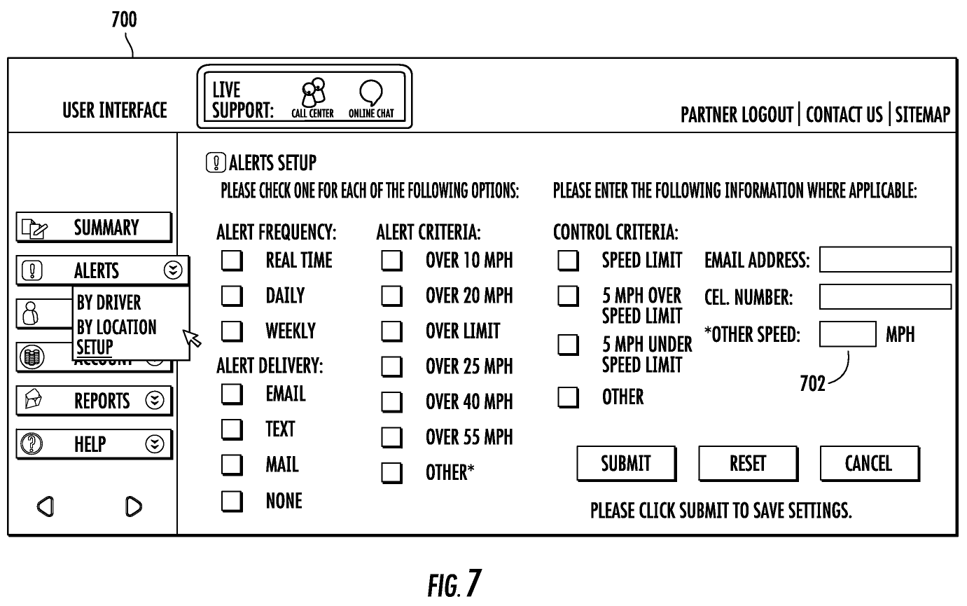

FIG. 7 illustrates an exemplary user interface configuration, or “Setup,” page 700. Device configurations may include alerts, controls, or other types of configurations. For example, the configurations may be customized such that speed or acceleration alerts are communicated to a remote user in real-time, hourly, daily, or “other.” Alerts may also be customized such that they are communicated according to a protocol specified by the remote user. For example, alerts may be communicated by email (e.g., SMTP), text (e.g., SMS or IM), mail, phone, or other formats. The configuration page 700 is further configured to allow a user to customize alert criteria (e.g., alert driver if speed limit exceeded, if speed is over “10 mph” above the speed limit, or “other”). If “other” speed is selected, the user may enter a custom or recommended configuration input into box 702. It is appreciated that selection of displayed criteria in various combinations (such as alert frequency=real time; alert delivery=text; and alert criteria=over limit) also constitutes user-customizable settings. In embodiments, the user-customizable settings also encompass recommended settings. When all of the user-customizable settings have been entered, the user may select “Submit” to save the configuration settings and to initiate configuration of the mobile device. Alternatively, the user has the option to “Reset” the configurations (e.g., to default settings), or to “Cancel” the configuration process. In embodiments, customized controls are also provided on the configuration page 700. Thus, the user interface may be configured to allow a user to customize vehicle control settings (e.g., cap speed at speed limit, cap speed to within “5 mph” above or below speed limit, or “other”). If “other” is selected, the user may enter custom or recommended control criteria (e.g., “3 mph” above the speed limit) into box 702. It is further appreciated that the alert or control criteria are not limited to those shown in FIG. 7, and that other criteria may be readily added to the configuration page 700 such as: bike zone, school zone, curve ahead, road work ahead, accident ahead, and more.

### Methods

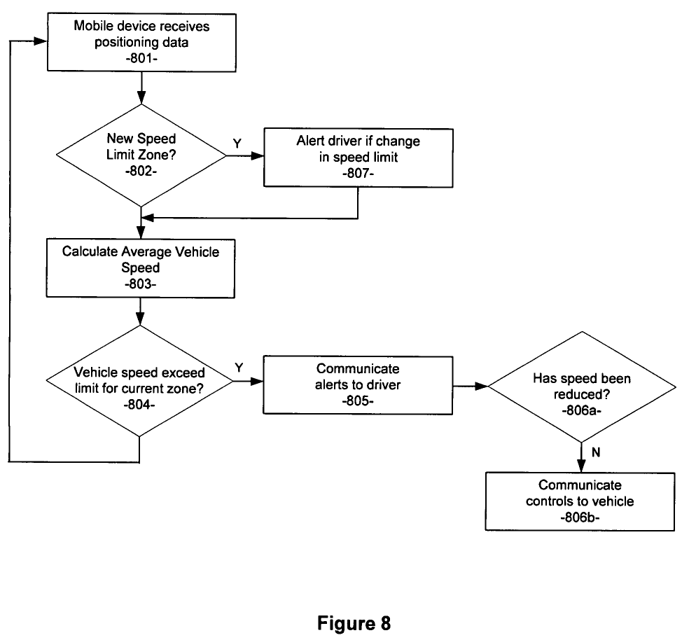

FIG. 8 is a vehicle configuration flowchart according to one embodiment of the present disclosure. According to step 801, data is exchanged at intervals between the mobile device 20 (containing downloaded location maps and associated legal speed limit data) and the GPS system 10 to monitor the vehicle's location. Based on current position and map data, the mobile device 20 senses entry into a new speed limit zone at 802. In step 803, the mobile device 20 records the vehicle speed for a certain timeframe and calculates the vehicle's average speed. At 804, the mobile device 20 compares the calculated average vehicle speed to a local speed limit stored in memory. If the computed average speed exceeds the legal limit on record for that location, the mobile device 20 sends an alert to the driver to reduce the driving speed at 805. In steps 806a and 806b, if the vehicle speed is not reduced within a certain amount of time, the mobile device 20 communicates with a speed governing device (such as a cruise control system, fuel injection system, ignition system, or other device) to gradually reduce the vehicle's speed and to cap it e.g., at the legal speed limit. If the computed average vehicle speed does not exceed the legal speed limit on record, the mobile device can alert the driver of any changes in the legal speed limit and send a signal to the vehicle control device to cap the vehicle speed at the new limit (step 807).

It is appreciated that in embodiments, vehicle alerts and controls may be initiated from instructions pre-programmed into mobile device 20 instead of, or in addition to, remotely configured vehicle alerts and/or controls. However, advantages of remotely providing device configurations from server 40 are that memory, processing, and/or bandwidth requirements of the mobile device 20 are reduced. As a result, the mobile device 20 is not required to frequently download large amounts of external data related to maps, weather, traffic, road work, etc. to determine a desired or recommended setting. Instead, remote customizable and/or recommended settings may be continuously fed from server 40 to the mobile device 20 in the form of small set(s) of instructions.

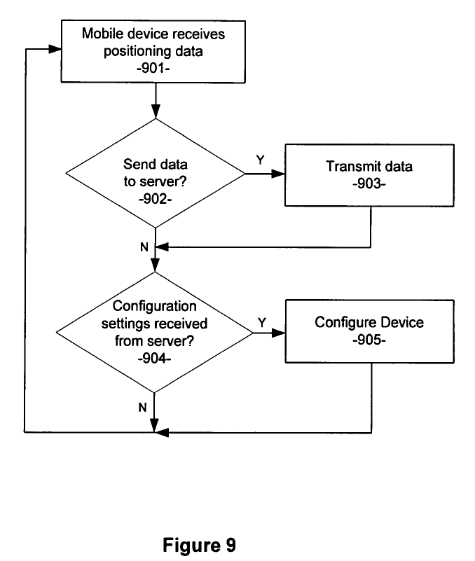

FIG. 9 is a mobile device 20 configuration flowchart according to another embodiment of the disclosure. As shown in step 901, the mobile device 20 receives positioning data from GPS system. At 902 the device 20 determines whether positioning, vehicle, and/or driver data need to be sent to server 40. For example, the mobile device may be configured to send such data at certain time intervals (e.g., every hour, every two hours, or “other”). If the answer to step 902 is yes, the mobile device transmits the data 903 to server 40 e.g., over a wireless GSM/GPRS connection. The mobile device 20 also may poll the transceiver/modem 22 to see if any configuration settings have been received from the server 40 (step 904). If configuration settings have been received, the device is configured and/or updates applied at step 905.

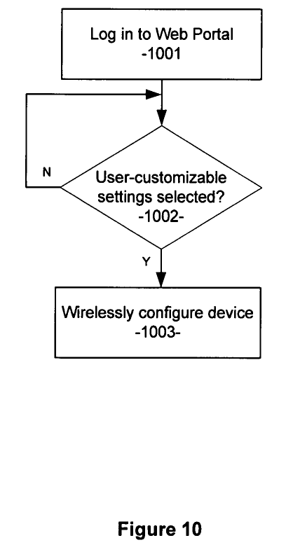

FIG. 10 is a flowchart for remotely configuring a vehicle from a web portal user interface according to a preferred embodiment of the present disclosure. As shown in step 1001, a remote user logs in to a secure a web portal maintained by server 40 and accessible by remote user devices 50 using Internet protocols such as TCP/IP, HTTP, WAP, FTP, etc. A secure connection may be established between user device 50 and the server 40 using VLANs, TLS, SSL or other secure communication mechanisms. If the remote user desires to configure device settings at 1002, the user may access the alerts or controls setup pages via the user interface (see FIG. 7a). Optionally, the user may set the vehicle alerts settings to “other” and specify a customizable speed limit in box 702. For example, a user may indicate that a vehicle should operate at “7 mph” less than the speed limit (e.g., under poor weather conditions or heavy traffic). Upon selecting “submit,” the settings are transmitted to the mobile device 20 whereby the device 20 is wirelessly configured at 1003 according to the settings selected by the user.

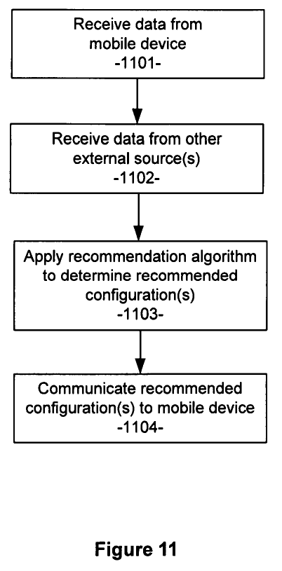

FIG. 11 is a flowchart of a recommendation algorithm according to the present disclosure. As shown in step 1101, the server 40 receives position, vehicle, activity, and/or driver data from the mobile device 20. According to step 1102, the server 40 also receives data feeds from host databases and/or additional external data sources 60_{1-N}. Such external data sources may include traffic data, legal speed data, weather data, road condition data, road-side work data, emergency services data, or data from other vehicles. Preferably, the server 40 utilizes an open source platform such that various external sources 60_{1-N} may provide dynamic and/or continuously updated data. The recommendation algorithm combines the data received from the mobile device 20 and the data received from external data sources 60 at step 1103 to determine recommended vehicle setting(s). In embodiments, the recommended setting(s) are communicated to the user interface configuration page 700. In this case, the user-customizable settings may include recommended settings, where a user has the option to select the recommended setting(s) on the user interface configuration page 700. In further embodiments, the recommendation algorithm may use artificial neural networks, modular neural networks, fuzzy systems, expert rules, correlation analysis, weights, etc. to determine recommended settings. In step 1104, the recommended settings are communicated to the mobile device 20.

It is appreciated that portions of the disclosure are implemented by way of computer software. The computer software may be any set of instructions that can be understood and implemented by a computer and thus take the form of one or more computer programs and/or file sets. The software can be written using any suitable computer language (including C++, Java, MySQL, etc.) or APIs as will readily be appreciated by those skilled in the art, and can be provided in any form, such as in the form of source code, object code, computer code, flow diagrams, or any other means by which those in the art convey information for implementation by way of computers. In general, the software of the invention comprises instructions for implementing the methods of the invention. The software may comprise all of the instructions in a single file or program, or the instructions may be separated into multiple files or programs, which when executed in conjunction with each other, execute the method of the invention. In addition, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible.

Those of skill in the art will immediately realize that the present invention may be provided entirely as hardware, entirely as software, or as a combination of software and hardware. It should also be apparent that the present invention may be provided as a computer program product on a computer-readable storage medium, such as that having a computer-readable program.

The present invention has been described at times above with reference to block diagrams and flowcharts. It is to be understood that each block of the block diagrams and flowcharts can be implemented by computer program instructions (i.e., software), which may be comprised on a general purpose computer or processor, special purpose computer or processor, or other programmable data processing apparatus to produce a machine or device. Execution of the instructions on the machine or device provides a means for implementing functions depicted in the diagrams and/or flowcharts.

Program instructions may be in the form of hardware, software, logic, firmware, etc. and are operable to provide the functionality described herein. Program instructions are further stored on computer readable media, that when executed, cause a computer or processor to perform the disclosed instructions. Examples of computer readable media include one or more of: magnetic disks, magnetic tape, optical disks, hard disks, flash memory, memory cards, memory sticks, smart cards, etc.

As can be seen, the disclosed systems and methods enable remote custom vehicle alerts and/or controls based on real time GPS and/or location based technology. Configurations may take place in real time, or alternatively may be scheduled to take place during “off peak” times to make efficient use of bandwidth and/or reduce transmission costs. For example, certain alert or speed settings may be made in real time for purposes of safety, while other settings (such as reporting) may be scheduled to take place e.g., within 24 hours.

It is also appreciated that vehicle alerts and controls may be initiated from instructions pre-programmed into mobile device 20 instead of, or in addition to, remotely configured vehicle alerts and/or controls. However, advantages of providing remote configurations are that memory, processing, and/or bandwidth requirements of mobile devices are reduced. As a result, mobile devices are not required to frequently download large amounts of external data related to maps, weather, traffic, road work, etc. to determine an optimal or recommended setting. Instead, remote customizable and/or recommended settings may be continuously fed from a server in the form of small set(s) of device instructions.

Preferably, the disclosed systems and methods also provide intelligent vehicle alerts and/or controls based on real time GPS and/or location based technology and external data feeds. Advantageously, open source platforms allow up-to-date data feeds to be dynamically received and integrated to provide recommended settings.

The systems and methods described in the present disclosure are also able to utilize global positioning and/or location-based technology to provide real time speeding alerts and to track driving behavior over time. For example, such data may be used to compile a “driver score” or “ranking” to reduce insurance premiums, improve safety, and more. In addition, operators can utilize global positioning and/or location-based technology to prevent inefficient fuel usage due to speeding.

Although fleet managers or owners have been primarily addressed as authorized users by way of example, other remote users may include: dispatchers, law enforcement personnel, network administrators, insurance providers, and others. In addition, various users may be afforded appropriate levels of access control to the portal functions. For example, some users may only be able to configure device alerts, while other users may be authorized to configure device alerts and controls. Additionally or alternatively, some users may only be able to issue standard configurations, while other users are authorized to perform custom configurations. Moreover, custom reports may be generated for different users based e.g., on authorization or access level.

It is appreciated that the disclosed methods encompass methods for conducting business over communication networks such as the Internet. For example, methods for doing business may include: receiving data from one or more mobile devices 20_{1-N} and/or one or more external data feeds at the remote server 40; combining and/or storing at least portions of the received information to derive information of interest to one or more particular users; and providing information for a fee. Examples of remote data feeds include, but are not limited to: traffic data, legal speed limit data, weather data, road condition data, roadside work data, emergency services data, and data from other vehicles. Received data may be combined to provide or compute various types of information related to “driver scores”, “rankings”, driver behavior, safety, fuel efficiency, and more. It is also appreciated that the received data or derived information may be stored in local memory of server 40 and/or one or more database(s) managed by the server 40. Thus, the methods may further include maintaining one or more database(s) of information (managed e.g., by the server 40, or host) relating to multiple mobile devices 20_{1-N} and/or information relating to one or more external data sources 60_{1-N}. As a result, the information may be stored and/or combined to provide customized information of interest to one or more users for a fee.

It will be apparent to those skilled in the art that various modifications and variations can be made in the practice of the present invention and in construction of the system and its component devices and software without departing from the scope or spirit of the invention. Other embodiments of the invention will be apparent to those skilled in the art from consideration of the specification and claims, and from practice of the invention. It is intended that the specification be considered as exemplary only.

1. A method for remotely configuring a mobile device communicatively coupled with a vehicle, the method comprising:
providing a remote user interface whereby a user may input user-customizable mobile device settings; and
wirelessly configuring the mobile device based on the user-customizable settings.

2. The method of claim 1, wherein the mobile device is configured to flag vehicle speeds or accelerations above a customized threshold specified by the user.

3. The method of claim 1, wherein the mobile device is configured to cap vehicle speed or acceleration at a customized threshold specified by the user.

4. The method of claim 1, wherein the mobile device is configured to communicate vehicle data and/or flags to the user according to a communication protocol specified by the user.

5. The method of claim 1, wherein the mobile device is configured to communicate vehicle data and/or flags to the user according to time intervals specified by the user.

6. The method of claim 1, wherein the user-customizable settings may be updated via the user interface on-the-fly.

7. A method for remotely configuring a mobile device communicatively coupled with a vehicle, the method comprising:
receiving data from the mobile device at a remote server;
receiving one or more external data feeds at the server;
inputting the mobile device data and/or external data to a recommendation algorithm;
applying the recommendation algorithm to calculate recommended vehicle settings; and
wirelessly configuring the mobile device based on the recommended settings.

8. The method of claim 7, wherein one or more external data feeds correspond to: traffic data, legal speed data, weather data, road condition data, road-side work data, emergency services data, or data from other vehicles.

9. The method of claim 7, wherein the recommendation algorithm combines the received data utilizing neural networks, fuzzy systems, and/or weights.

10. The method of claim 7, wherein the mobile device is configured to flag vehicle speeds or accelerations that exceed the recommended setting(s).

11. The method of claim 7, wherein the mobile device is configured to generate alerts when vehicle speeds or accelerations exceed the recommended setting(s).

12. The method of claim 7, wherein the mobile device is configured to cap vehicle speeds or accelerations at the recommended setting(s).

13. The method of claim 7, wherein the mobile device is configured on-the-fly.

14. A system for enabling a user to remotely configure a mobile device communicatively coupled with a vehicle, the system comprising:
a mobile device in operative communication with a global positioning system and a remote server;
the remote server including:
a vehicle data receiving module;
a user interface module configured to display vehicle and/or driver data to the user;
an input module configured to receive customizable configuration inputs from the user; and
a transmission module configured to transmit configuration settings to the mobile device in response to the user inputs;
whereby the mobile device is wirelessly configured based on the user-customizable settings.

15. The system of claim 14, wherein the mobile device is configured to flag vehicle speeds or accelerations above a customized threshold specified by the user.

16. The system of claim 14, wherein the mobile device is configured to alert the driver of vehicle speeds or accelerations above a customized threshold specified by the user.

17. The system of claim 14, wherein the mobile device is configured to cap vehicle speeds or accelerations at a threshold specified by the user.

18. The system of claim 14, wherein the mobile device is configured to communicate vehicle data and/or flags to the user according to a communication protocol specified by the user.

19. The system of claim 14, wherein the mobile device is configured to communicate vehicle data and/or flags to the user according to a time interval specified by the user.

20. The system of claim 14, wherein the user interface is configured to receive customizable configuration inputs from the user on-the-fly.
